(19) United States
(12) Patent Application Publication
(10) Pub. No.: US 2025/0170948 A1
(43) Pub. Date: May 29, 2025

(54) CROSS-BEAM CARGO STABILIZER

(71) Applicant: Toni LOBER, Dortmund (DE)

(72) Inventor: Toni LOBER, Dortmund (DE)

(21) Appl. No.: 18/428,901

(22) Filed: Jan. 31, 2024

(30) Foreign Application Priority Data
Nov. 27, 2023 (EP) 23212251.5

(51) Int. Cl. B60P 7/15

(52) U.S. Cl. CPC B60P 7/15

(57) ABSTRACT

A brace assembly for use in a load space having side walls carrying vertical tracks has a cross beam extending between the tracks. A respective slide clamp on each of the ends is vertically slidable along the respective track. A respective release slide is movable in each of the slide clamps between a locked position and an unlocked position. A respective locking formation in each of the slide clamps is couplable to the respective track and can fix the respective slide clamp on the respective track in the locked position of the release slide and allow the slide clamp to move along the respective track in the unlocked position of the release slide. The slide clamp moves the release slide into the unlocked position when the cross beam extends nonorthogonally to the respective track and holds the release slide therein when the cross beam extends substantially orthogonallly from the track.

### FIELD OF THE INVENTION

The present invention relates to a brace assembly. More particularly this invention concerns such an assembly used in a load space to brace and separate cargo.

### BACKGROUND OF THE INVENTION

The invention relates to a brace assembly for use in a load space and having at least one cross beam that can be fixed between two normally parallel and vertical walls and that engages at each end with a releasable slide clamp in a respective track of the wall. The slide clamp has an element with at least one locking formation that, in an unlocked position determined by the release slide, releases the slide clamp from the track and in a locked position fixes the respective brace-beam end to the track.

The tracks extend in this case mostly vertically, and the cross beam extends at least generally horizontally between the two tracks. In this way the cross beam can subdivide the load space filled for example with pallets or also can support certain goods directly. This enables subdivision and better utilization of the volume of the load space.

Such a brace assembly is described in U.S. Pat. No. 8,979,451 where it is also equipped with a spring-loaded cable to maintain a position extending horizontally and perpendicular to the tracks. Here, the height or inclination of the cross beam is changed in a displacement direction between the load-space side walls. In US 2023/0219482 the slide clamp has a release slide that provides for longitudinal adjustment of the locking formation in the axial direction of the cross beam.

Such systems have problems in practice. For example, when using the cable according to U.S. Pat. No. 8,979,451 there is the problem that the cable can be damaged inside the track, become dirty, or can otherwise be jammed. In the system of US 2023/0219482 loading of the release slide for axial adjustment of the locking formation requires a significant actuating force that is difficult during normal day-to-day operation. In addition, significantly, any vehicle movements and thus also movements of its load-space walls relative to each other can under circumstances lead to an undesired unlocking or releasing of the slide clamps, resulting in shifting of and damage to the loaded cargo.

In the case of another brace assembly described in EP 3,551,499, first and second motors are provided each associated with a respective one of the tracks for moving the cross beams along the tracks. While such a procedure is convenient, it requires perfect operation of such motors as well as an additional power supply. This is on the one hand costly and on the other hand problematic with regard to the additional energy supply.

### OBJECTS OF THE INVENTION It is therefore an object of the present invention to provide an improved brace assembly of the above-described general type.

Another object is the provision of such an improved brace assembly that overcomes the above-given disadvantages, in particular that, taking into account a compact and cost-optimized structure, functions very well over a long service life.

### SUMMARY OF THE INVENTION

A brace assembly for use in a load space having side walls carrying vertical tracks has according to the invention a cross beam extending between the walls and having ends each juxtaposed with a respective one of the walls. A respective slide clamp on each of the ends is vertically slidable along the respective track. A respective release slide is movable in each of the slide clamps between a locked position and an unlocked position, and a respective locking formation in each of the slide clamps is couplable to the respective track and can fix the respective slide clamp on the respective track in the locked position of the release slide and thereby prevent the slide clamp from moving along the respective track in the locked position of the release slide. Structure on the slide clamp moves the release slide into the unlocked position when the cross beam extends nonorthogonally to the respective track and holds the release slide in the locked position when the cross beam extends substantially orthogonallly from the respective track. Thus, moving the cross beam into an angled position shifts the slide clamp rotatably connected thereto into its unlocked position.

Hence, in order to move the cross beam normally up or down on the walls of the load space, it is necessary to shift the slide clamps into their unlocked positions. This takes place according to the invention by moving the cross beam into an angled position not extending orthogonally of the cross beam. In this angled position, the cross beam can telescope as required. In the angled position of the cross beam the usually linearly loadable release slide is pulled back and the slide clamp is unlocked. If, on the other hand, the cross beam assumes its normal horizontal position extending orthogonally to the tracks, the release slides are not acted upon and are in their locked positions. As a result, the load-bearing beam can be moved relative to the wall-mounted tracks when extending nonorthogonally to these tracks, in the unlocked position of the slide clamp.

In contrast to the prior art of the technology in particular according to US 2023/0219482, according to the invention the locking formation and consequently also the slide clamp for unlocking with respect to the cross beam and thus also the track is not acted upon axially. Rather, the unlocking is carried out by moving the cross beam at one end into the described angled position with respect to the tracks and thus also the walls. In the angled position of the cross beam, the slide clamps are automatically both shifted into their unlocked position by their respective release slides. Subsequently the cross beam can be moved in the tracks as desired.

This enables a particularly low-force and simple actuation of the locking formations engaging in the respective track by the release slide. According to the invention the angled position of the cross beam for moving the slide clamp into its unlocked position ensures in addition that the unlocked position of the slide clamp expressly is not brought about by for example vehicle movements unintentionally. This is because the angle of the inclination between the cross beam and the associated side wall or the track observed at this location is not reached during travel, so that, in contrast to the state of the art according to US 2023/0219482, vehicle movements or general movements of the load space during operation according to the invention do not lead to an unintentional unlocking of one or both slide clamps.

In fact the angled position of the cross beam in general acts on the release slide and moves it out of the locking position. The action of the release slide can be brought about mechanically by a shoulder on the slide clamp. In principle the release slide can also be acted upon independently of this for example linearly and manually, in order to transfer the respective slide clamp into the unlocked position.

The initial actuation of the slide clamps of the cross beam may be carried out in that one of the slide clamps is first manually unlocked by manually moving the release slide. Since the cross beam is generally telescopic, the cross beam can subsequently be inclined, so that the cross beam is shifted into an angled position that in effect pivots the cross beam relative to the slide clamp and thereby moves the other slide clamp of the cross bar into its unlocked position.

In fact the locking formation engages as a rule in one of several openings in the track. Furthermore the design is such that the slide clamp can move axially along the tracks and is guided inside the tracks by stops. The relevant locking formation now allows the height alignment of the cross beam. In order to compensate for any changes in length at this point, the cross beam can generally be telescopic for this purpose.

In the general case several locking formations are provided. In addition it has proven effective to put the locking formations on the outer periphery of a locking wheel. The action of the release slide for unlocking the slide clamp corresponds in this case to the engagement of the locking formation opposite the locking formation in the sliding rail by a locking bar. If now the locking bar is released by the release slide, the slide clamp is in the unlocked position and the wheel can rotate. This makes it possible for the wheel to in effect roll on the track.

In the locked position of the slide clamp, on the other hand the locking bar ensures that the locking formation nearest the locking bar is arrested and thus also the locking wheel is blocked against rotation. This occurs when typically the locking formation opposite the locking bar engages in for example an opening or recess of the track and the cross beam with its slide clamp is fixed in this position in the track. In this way the cross beam can be fixed at the desired height between both tracks connected by the cross beam between the opposite walls.

The locking wheel with the locking formations provided on the outer periphery typically has a spiral spring that may be inside the wheel. This coiled spring is tensioned in a displacement direction of the cross beam between the walls and slips in the opposite direction. In this way the load-bearing beam in unlocked position can move with slide clamps to the desired height between the walls and subsequently can be leveled to lock both slide clamps.

The slide clamps can be installed in the tracks at openings provided at the upper and/or lower ends of the tracks. Such an opening is preferably at a lower end of each track, so that a particularly simple installation is possible and subsequently the cross beam is oriented at the desired height as described above.

Furthermore, the spiral spring ensures that it is firmly connected to the locking wheel. An axle serves for tensioning the spring. To this end, the inner end of the spiral spring is connected to the axle and its outer end to the locking wheel. To wind up the coiled spring, the cross beam is moved downward on its tracks. Upward movement unwinds or detensions this spring until the locking wheel slips. This prevents damage to the spiral spring in the event of a torsional overload when the cross beam is moved upward in the tracks.

Furthermore the inner end of the spiral spring connected to the axle is in turn secured by a slip coupling to a nonrotating part, here indirectly to the cross beam. This is done by providing each end of the axle with a rotationally fixed friction washer that is, for instance, sandwiched between the pivotal slide clamp and the cross beam such that, when sufficient torque is applied to the axle, it can rotate relative to the slide clamp and/or cross beam, thereby preventing overstressing the spring or locking-up of the slice clamp while allowing the spring to be prestressed sufficiently to take up much of the weight of the cross beam and facilitate lifting it.

As already explained, the cross beam is fixed at its two ends by the respective slide clamps to the respective tracks in which the cross beam moves vertically. Locking in place is effected at each end by engagement of one of the respective locking formations in holes of or between teeth of the respective track to vertically solidly arrest the cross beam at the desired height extending perpendicular to the respective tracks.

The above-described locking wheel carrying the locking formations is normally rotatable about the above-described axis of the axle. The locking formations project radially outwardly from and are equispaced angularly around the outer periphery of the locking wheel. Each axle also serves for pivotally interconnecting the slide clamp and the respective end of the cross beam in that ends of the axle are seated in the slide clamp and the axle passes between these ends through circular transverse holes formed in the normally tubular cross beam. The one or more locking formations on the slide clamp are engageable in holes or between teeth of the respective track.

Two flanges of the slide clamp and the locking wheel between them thus can pivot about the respective axle connected to the cross beam. As a result, actuation of the locking element of the slide clamp not only allows the wheel carrying the coupling formations to rotate but also allows the cross beam to be set skew, that is not orthogonally, to the tracks, since the load clamp can rotate about the axis of the axle on the respective end of the cross beam.

The release slide is movable linearly that is in a straight line, generally parallel to a longitudinal axis of the cross beam, between the locked position and the unlocked position. In the locked position, the release slide presses a locking formation of the slide clamp into engagement with a complementary recess formation of the track and arrests the respective end of the cross beam on this track. In the unlocked position, the release slide frees the locking formation and thereby allows the respective end of the cross beam to slide up or down in the track. Since this linear movement is parallel to the normally horizontal cross beam, it also is horizontal. Thus up/down jarring of the brace assembly, as for instance when being used in a truck having the load space, will not jar the slide clamps so as to release them. Only when the cross beam is angled, that is not extending orthogonally to the tracks, are the slide clamps free to slide vertically in the tracks. This linear actuation of the release slide can be carried out either manually or by placing the cross beam at an angle so the release slide is cammed in by the flanges into the unlocked position.

The release slide is generally and U-shaped in cross section. Furthermore, the release slide essentially consists of a locking formation and the part. The U-base of the release slide observed in this context thereby advantageously interacts with the locking formation and the locking wheel like the above-mentioned locking bar. To this end, the locking bar as a guide formation passes through the linear guide in the cross beam, so that the impact of the release slide or release part is axially of the cross beam and ensures that the locking bar is removed from the relevant locking formation or engages therein.

The locking bar is furthermore equipped with at least one spring acting on it in direction of the locking formation or of the locking wheel. This causes the locking bar when not actuated to bear on and prevent rotation of the locking wheel while forcing one of its locking formations into engagement with the respective track, thereby locking the respective slide clamp to the track. Furthermore the spring in question ensures that the locking bar effectively floats relative to the part and allows some limited relative movement of the release slide and the locking wheel. To this end, the spring is usually a torsion spring. Due to the friction between the locking bar and the locking formation or the locking formation cylinder, the locking bar consequently always remains in its locking position or in the locking position of the slide clamp, as long as force is applied to the cross beam.

The release slide is in turn acted upon with respect to the cross beam by a further spring, namely along a linear guide provided or formed in the respective end of the cross bar. The release slide normally engages the guide formation with a locking bar slidable longitudinally in the cross beam. In addition, the torsion spring and the spring provide the floating support of the locking bar relative to the operating part of the release slide. The locking bar and the part are both components of the release slide. Thanks to the floating bearing of the locking bar, any changes in length can be compensated for in the event of a (slight) inclination of the cross beam by vehicle movements. As long as there is a load is on the cross beam, the floating bearing with the help of the spring or torsion spring ensures, that (slight) movements of the part relative to the locking bar caused by vehicle movement are absorbed and will not release any of the slide clamps. The part may move relative to the locking bar due to the floating bearing and the interposed spring or torsion spring. The normality assumed locked position is not changed by this, because the load acting on the cross beam ensures that the locking bar and the associated locking formation after as before interact with each other and remain in engagement.

For the actual unlocking process it is necessary on the other hand that the locking bar be moved linearly relative to the locking formation. This is effected by manual action to axially shift the release slide or automatically when the cross beam is inclined. This presupposes in both cases that the cross beam is not loaded with an additional load, so that the locking bar can be separated from the locking formation.

In addition, the release slide is formed with a cutout or notch receiving the axle of the locking wheel. The cutout is designed to open longitudinally away from the cross bar so that, when a load is applied to the release slide, it effects the unlocked position of the slide clamp and the release slide is separated from the axle. This movement is accompanied by action of the locking bar to release the previously trapped locking formation.

This releases the locking wheel so it can pivot. At the same time this allows pivoting of both locking wheels between their guide flanges on their tracks. This corresponds to the unlocked position of the slide clamps.

The result is thereby a brace assembly that can be moved with little force and in a functionally safe manner from its locked position of its slide clamps into its unlocked position. This adjustment is possible because the release slide works on the locking bar that releases the locking wheel. This allows the locking wheel to rotate or roll on the track between the guide flanges.

As a consequence of this, the slide clamp can be pivoted at each end of the cross beam relative to the cross beam about the common axis of rotation of the guide flanges and of the locking wheel. This allows the cross beam to be moved relative to the track. This can be realized by an operator typically manually and with little force.

In contrast to the prior art according to above-cited US 2023/0219482, according to the invention the linear loading of the release slide for unlocking is coupled with floating bearing of the locking bar opposite of the part. Due to the floating bearing, any displacements of the cross beam due to for example vehicle movements do not cause the slide clamp to unintentionally be unlocked. This achieves an enormous safety gain in comparison with the state of the art. This is the essential advantage to the instant invention.

It should in this context still be emphasized, that the load-bearing beam assembly can be combined with any load space, for example the load space can be the cargo space of a truck, of a railroad wagon, a ship's hold, or a cargo container. Furthermore the tracks can be of varied design and construction, because it is only important that the locking formation detachably secure the slide clamp to the track.

### BRIEF DESCRIPTION OF THE DRAWING

The above and other objects, features, and advantages will become more readily apparent from the following description, reference being made to the accompanying drawing in which:

FIG. 1 is a rear view of a load space equipped with a brace assembly according to the invention;

FIG. 2 is a large-scale exploded view of one of the slide clamps of the assembly and an end of a cross beam;

FIGS. 3A and 3B show 90E offset longitudinal sections of the slide clamp in the locked position;

FIGS. 4A and 4B are views like FIGS. 3A and 3B with the slide clamp in the unlocked position; and

FIGS. 5A and 5B are cross-sectional and side detail views of one of the tracks.

### SPECIFIC DESCRIPTION OF THE INVENTION

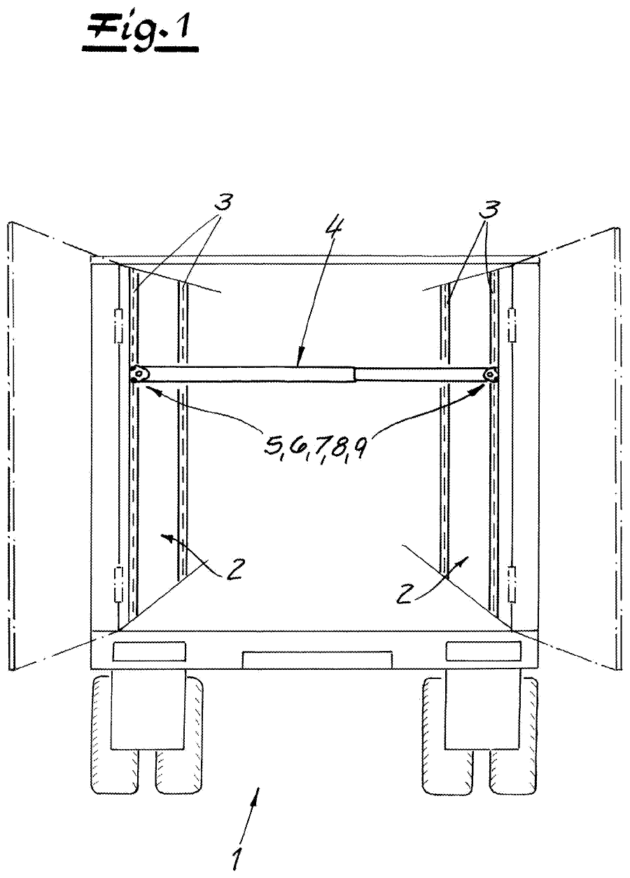

FIG. 1 shows a brace assembly for use in a load space 1 that, according to the invention, is the cargo area of a truck or of a semitruck trailer. It can also be the cargo space of a railroad car or a ship's hold or even a simple shipping container, in fact anything adapted to transporting freight. Here the load space 1 has normally vertical, parallel, and spaced side walls 2. Each wall 2 is provided with one or more vertical tracks 3. A floor and a ceiling further delimit the load space 1, although the roof is not essential.

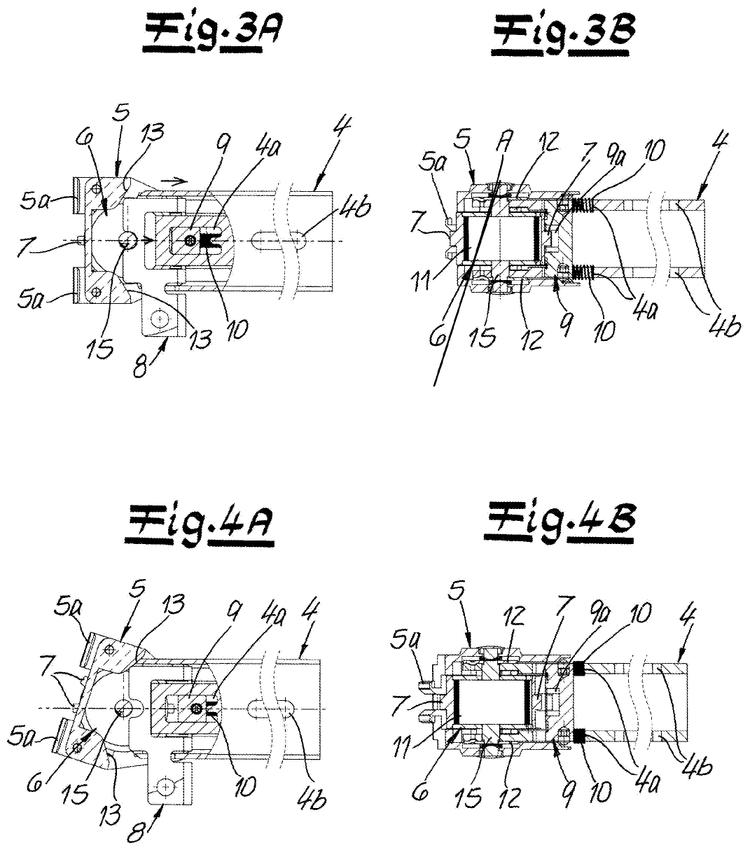

The tracks 3 can be bridged by one or more cross beams 4 extending between the opposite walls 2 and normally fixed to the tracks 3, only beam 4 being shown in FIG. 1. In practice several cross beams 4 are employed extending between different tracks 3. As shown in FIGS. 3A to 4B the beam 4 is provided at each end with a respective slide clamp 5-9 that can slide on the respective track 3 when unlocked vertically and longitudinally along the respective track 3 and that can be locked at any vertical position thereto.

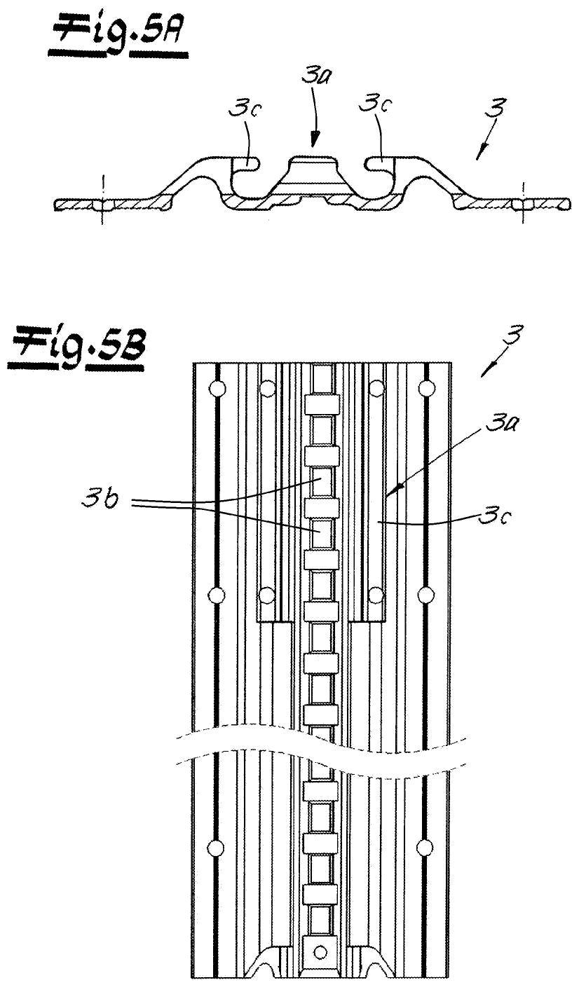

FIGS. 5A and 5B show how each track 3 is formed with a respective guide groove 3a in which the slide clamp 5-9 of a respective beam 4 can fit and slide vertically longitudinally. The guide groove 3a is delimited by lips 3c that partially close it so as to capture the respective slide clamp 5-9 and that end as shown in FIG. 5B at a cutout or opening short of the lower end of the respective track 3 on the floor. This way a slide clamp 5-9 can be fitted to the track 3 and into the guide groove 3a at the lower end of one of the tracks 3 and raised to be captured therein while still being able to slide vertically.

The slide clamp 5-9 is in turn equipped with a release slide 8, 9 for formations 7 that can engage into recesses 3b of the track 3 and ensure that in the locked position the release slide 8, 9 vertically arrests the respective end of the beam 4 on its track 3. The locking formations 7 can release the slide clamp 5-9 in an unlocked position of the respective slide clamp 5-9 in which the beam ends can move vertically in the tracks 3.

As a consequence of this, the cross beam 4 in the unlocked position of both of its slide clamps 5-9 can be moved vertically.

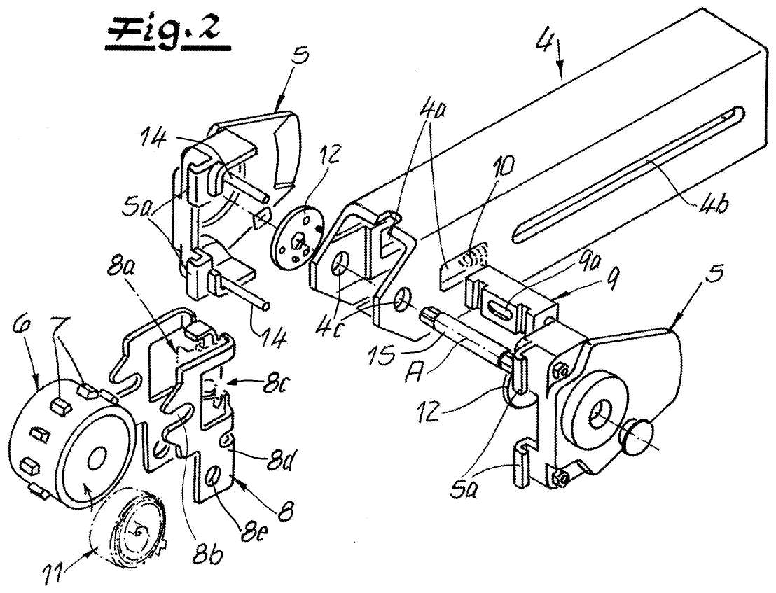

In order to compensate for any length increases when angled, the cross beam 4 is formed of two square-section parts telescoping together at its center. More particularly as shown in FIG. 2, the outer part is formed with a pair of linear slots 4b through which project an unillustrated bolt seated in the inner part to limit the relative longitudinal movement of the two parts. Of course other possibilities for telescoping action of the cross beam 4 are also conceivable and embraced by the invention.

In accordance with the invention, the design is such that for unlocking an end of the cross beam 4, the locking formations 7 can move relative to the track 3 and thus the cross beam 4 can pivot. As described in more detail below, unlocking one end of the cross beam 4 is done by pivoting this slide clamp 5-9 from its locked into its unlocked position. To this end there is an array of such locking formations 7 distributed uniformly angularly on the outer periphery of a wheel 6 carried on an axle 15 centered on and extending along an axis A perpendicular to a longitudinal axis of the beam 4.

Each axle 15 is journaled in holes 4c of the beam end and serves at the same time for rotatably supporting a pair of guide flanges 5 sliding in the track 3 and interconnected by transverse rods 14 flanking the pointed outer end of the beam 4. In fact according to this embodiment the two guide flanges 5 flanking the locking wheel 6 are part of each of the slide clamps 5-9. The guide flanges 5 have bent-out ends 5a that engage in the respective track groove 3a under the lips 3c for smooth vertical sliding of the respective slide clamp 5-9 in its track 3. In addition, these bent ends 5a prevent the end of the respective cross beam 4 from pulling out of the respective track 3.

Each pair of guide flanges 5 and the respective locking wheel 6 are pivotal with the respective common axle 15 that connects them to the cross beam 4. This allows the slide clamp 5-9 to pivot relative to the beam 4 between the locked position of FIGS. 3A and 3B into the unlocked position of FIGS. 4A and 4B, for example in a clockwise direction. As a consequence of this, pivoting described in more detail below, the slide clamp 5-9 is unlocked from its track 3 and the end of the cross beam 4 can be moved vertically in the track 3. The slide clamp 5-9 is unlocked by tilting the cross beam 4.

The release slide 8, 9 previously mentioned is part of the slide clamp 5-9 like the locking wheel 6 and the locking formations 7 thereon. Each clamp 5-9 further has one pair of the guide flanges 5 flanking a respective locking wheel 6. Each release slide 8, 9 is formed of two coupled-together slide parts 8 and 9, the former being of metal formed into a U-shape and the latter a short machined bar. The part 9 slides longitudinally of the cross beam in linear guide slide slots 4a of the cross beam 4.

As mentioned above, the slide part 8 is U-shaped with its legs bridged by the bar 9 that fits in cutouts 4c and that interacts with the locking formations 7. A spring 8a provides a flexible connection between the part 8 on the one hand and the locking bar 9 on the other hand.

In fact in this way the locking bar 9 is movable relative to the part 8. For this, the spring 8a is designed according to this nonlimiting embodiment as a spring. In addition, friction between the locking bar 9 and the locking wheel 8 or rather its outer surface ensures that the locking bar 9 remains in the locking position as long as a load is present on the cross beam 4 or engages with this. The slide clamp 5-9 together with the locking bar 9 then of course are in the locked position.

To this end, the locking bar 9 has a recess 9a in which in the locked position one of the locking formations 7 of the locking wheel 6 of the slide clamp 5-9 can engage. The locking formation 7 engaging in the recess 9a of the locking bar 9 is in general the formation 7 diametrically opposite the locking formation 7 engaged for locking the slide clamp 5-9 in a recess 3b of the track 3. As long as the locking bar 9 with its recess 9a receives one of the locking formations 7, the locking wheel 6 cannot rotate and the slide clamps 5-9 are in their locked positions and cannot move relative to the track 3.

To this end, a spring 10 biases the locking bar 9 toward the locking formation 7. The spring 10 is provided at the end of the linear guide 4a inside the cross beam 4. The spring 10 ensures that the locking bar 9 is biased into contact with the locking wheel 6. Furthermore, the spring 10 together with the spring 8a ensures floating movement of the locking bar 9 relative to the part 8.

In addition, as shown by a comparative view of FIGS. 2 and 3A to 4B, the release slide 8, 9 or its part 8 has outwardly open cutouts 8b receiving the axle 15. This allows the part 8 or the release slide 8, 9 as a whole to move to the right relative to the axle 15 from the locked position of the slide clamp 5-9 as shown in FIGS. 3A and 3B to the unlocked position of FIGS. 4A and 4B as shown by the arrow in FIG. 3A. This movement of the part 8 has the consequence that the locking bar 9 is moved against the force of the spring 10 also to the right, which leads in turn to release of the locking wheel 6 when one of its formations 7 disengages from the recess 9a.

This also allows the formation 7 opposite the locking bar 9 to roll out of the detent or opening 3b in the track 3 by rotation of the wheel 6. The slide clamp 5-9 moves in this manner from the unlocked position of FIGS. 3A and 3B to the unlocked or release position of FIGS. 4A and 4B. Thus the release slide 8, 9 moves linearly relative to the cross beam 4 and angularly about the common axis A, for example here clockwise. Meanwhile, the flanges 5 engage with their bent-over ends in the track 3. Then the slide clamp 5-9 can move relative longitudinally of the associated track 3. The same applies for the cross beam 4.

A further spring or spiral spring 11 shown in FIG. 2 is of particular importance. The coil spring 11 is inside the locking wheel 6. The outer end of spring 11 is fixed to the locking wheel 6 and the inner end is rotationally fixed in one direction to the axle A. This direction of rotation corresponds to downward movement of the cross beam 4 toward the floor connecting the two walls 2 with each other. In the opposite upward direction the spring 11 is detensioned until the connection to the tracks 3 slips. This prevents damage to the spiral spring 11.

In addition, the exploded view of FIG. 2 also shows that the axle 15 is fixed at both ends to washers 12 rotatable in the guide flanges 5. The lock washers 12 ensure that the axle 15 can slip in the event of a predetermined high level of tension on the spiral spring 11. In this way not only is damage to the spiral spring 11 avoided, but this can also be converted into a desired and pretensioned state by a corresponding rotation of the axis A.

As previously already explained, at least the angled position of the cross beam 4 ensures that both of the slide clamps 5-9 are shifted into their unlocked position. This takes place via the release slide 8, 9. In the mentioned angled position of the cross beam 4 the part 8 of the release slide 8, 9 is acted upon by shoulder edges 13 of the flanges 5. These shoulders 13 on the guide flanges 5 ensure that during the transition from the neutral or locked position of the slide clamp 5-9 of FIGS. 3A-3B to the unlocked position of FIGS. 4A-4B the part 8 is cammed by the shoulder surfaces 13 to the right, and compresses the spring 10 while pushing the element 8, 9 to the right to disengage the formation 7 and free the wheel 6 to rotate. The same happens then, if the part 8 is manually shifted, typically by a pull to the right as seen in FIGS. 3A and 4A by action on the depending arm 8. To this end an operating element like a handle is attached to a hole 83 in the part 8d.

The part 8 thus moves axially or longitudinally of the cross beam 4. This is ensured by the locking bar 9 that engages the linear guide 4a on the cross beam 4. As a consequence, any angled position of the cross beam 4 relative to the tracks 3 consequently also relative to the floor connecting the two walls 2 to each other, automatically moves both slide clamps 5-9 into their unlocked positions.

I claim:

1. A brace assembly for use in a load space having side walls carrying vertical tracks, the assembly comprising:
a cross beam extending between the walls and having ends juxtaposed with the walls;
a respective slide clamp on each of the ends and vertically slidable along the respective track;
a respective release slide movable in each of the slide clamps between a locked position and an unlocked position;
a respective locking formation in each of the slide clamps couplable to the respective track and fixing the respective slide clamp on the respective track in the locked position of the release slide and allowing the slide clamp to move along the respective track in the unlocked position of the release slide; and
structure on the slide clamp moving the release slide into the unlocked position when the cross beam extends nonorthogonally to the respective track and holding the release slide in the locked position when the cross beam extends substantially orthogonallly from the respective track.

2. The brace assembly according to claim 1, wherein the slide clamps each include:
a locking wheel rotatable about an axis in the slide clamp and having an outer periphery carrying several of the locking formations spaced angularly.

3. The brace assembly according to claim 2, wherein the slide clamps each include:
an axle extending along the axis and rotatably carrying the wheel; and
a spiral spring connected between the wheel and the axle and tensionable urging the wheel in one angular direction; and
a coupling between the spring and the wheel or the axle and permitting relative angular movement of the spring relative to the wheel or the axle.

4. The brace assembly according to claim 3, wherein the structure includes:
a flange in which the axle is journaled, and slidable in the respective track.

5. The brace assembly according to claim 4, wherein there are two of the flanges flanking the wheel axially.

6. The brace assembly according to claim 5, wherein the axle is journaled in the respective end of the cross beam.

7. The brace assembly according to claim 1, wherein the release slide is shiftable longitudinally in the cross beam.

8. The brace assembly according to claim 1, wherein the release slide includes a bar slidable in longitudinal guides of the respective end of the cross beam.

9. The brace assembly according to claim 1, wherein the release slide is U-shaped.

10. The brace assembly according to claim 9, wherein the release slide has an actuating arm.

11. The brace assembly according to claim 8, wherein the guides are longitudinal slots in the respective end of the cross beam.

12. The brace assembly according to claim 8, wherein the slide clamps each include:
a spring urging the bar into operative engagement with the formation in the locking position of the slide clamp.

13. The brace assembly according to claim 3, wherein the release slide has two arms each formed with a slot engaging around the axle.

14. The brace assembly according to claim 13 wherein the slot is open longitudinally away from the respective end of the cross beam.

15. The brace assembly according to claim 6, wherein the structure further includes
surfaces on the flanges that cam the release slide away from the track on movement of the cross beam into a position nonorthogonal to the respective tracks to disengage the formation from the track.
